(19) United States
(12) Patent Application Publication
(10) Pub. No.: US 2012/0221552 A1
(43) Pub. Date: Aug. 30, 2012

(54) METHOD AND APPARATUS FOR PROVIDING AN ACTIVE SEARCH USER INTERFACE ELEMENT

(75) Inventors: Erika Piia Paulina Reponen, Tampere (FI); Jaakko Olli Taavetti Keränen, Tampere (FI)

(73) Assignee: Nokia Corporation, Espoo (FI)

(21) Appl. No.: 13/071,270

(22) Filed: Mar. 24, 2011

Related U.S. Application Data
(60) Provisional application No. 61/447,200, filed on Feb. 28, 2011.

(51) Int. Cl. G06F 17/30

(52) U.S. Cl. 707/722; 707/E17.014

(57) ABSTRACT

An approach is provided for presenting a global view of desired information at specific locations that correspond to the desired information with respect to a start position. An element of a user interface receiving a search parameter enables processing of the search parameter to yield location information of the desired information. The location or locations of the desired information are then presented to a user on the user interface.

### RELATED APPLICATIONS

This application claims the benefit of the earlier filing date under 35 U.S.C. §119(e) of U.S. Provisional Application Ser. No. 61/447,200 filed Feb. 28, 2011, entitled “Method and Apparatus for Providing an Active Search User Interface Element,” the entirety of which is incorporated herein by reference.

### BACKGROUND

Service providers (e.g., wireless, cellular, etc.) and device manufacturers are continually challenged to deliver value and convenience to consumers by, for example, providing compelling network services. One area of interest has been the development of services for providing location-based information over, for instance, the Internet, in response to queries or searches for people, places or things. This desire to search for online location information has resulted in an abundance of available potentially relevant location-based information. Accordingly, service providers and device manufacturers face significant technical challenges to enable users to discover, access, and view such location information in an efficient and effective manner.

### SOME EXAMPLE EMBODIMENTS

Therefore, there is a need for an approach for efficiently presenting the results of location-based searches.

According to one embodiment, a method comprises receiving one or more search parameters at an element of a user interface, the element presented at a position within the user interface. The method also comprises processing and/or facilitating a processing of the one or more search parameters to determine one or more search results. The method further comprises determining one or more other positions within the user interface based, at least in part, on the one or more search results. The method still further comprises causing, at least in part, presentation of the element at at least one of the one or more other positions.

According to another embodiment, an apparatus comprises at least one processor, and at least one memory including computer program code, the at least one memory and the computer program code configured to, with the at least one processor, cause, at least in part, the apparatus to receive one or more search parameters at an element of a user interface, the element presented at a position within the user interface. The apparatus is also caused to process and/or facilitate a processing of the one or more search parameters to determine one or more search results. The apparatus is further caused to determine one or more other positions within the user interface based, at least in part, on the one or more search results. The apparatus further causes, at least in part, presentation of the element at at least one of the one or more other positions.

According to another embodiment, a computer-readable storage medium carries one or more sequences of one or more instructions which, when executed by one or more processors, cause, at least in part, an apparatus to receive one or more search parameters at an element of a user interface, the element presented at a position within the user interface. The apparatus is also caused to process and/or facilitate a processing of the one or more search parameters to determine one or more search results. The apparatus is further caused to determine one or more other positions within the user interface based, at least in part, on the one or more search results. The apparatus further causes, at least in part, presentation of the element at at least one of the one or more other positions.

According to another embodiment, an apparatus comprises means for receiving one or more search parameters at an element of a user interface, the element presented at a position within the user interface. The apparatus also comprises means for processing and/or facilitating a processing of the one or more search parameters to determine one or more search results. The apparatus further comprises means for determining one or more other positions within the user interface based, at least in part, on the one or more search results. The apparatus further comprises means for causing, at least in part, presentation of the element at at least one of the one or more other positions.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-35, and 56-58.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an active search user interface element, according to one embodiment;

FIG. 2 is a flowchart of a process for providing an active search user interface element, according to one embodiment;

FIGS. 3A-3C are diagrams that illustrate example user interfaces used in the process of FIG. 2, according to various embodiments;

FIG. 4 is a diagram of a user interface utilized to present an augmented reality view of the active search UI element and its search results, according to one embodiment;

FIG. 5 is a diagram illustrating an augmented reality view employing a transparency effect, according to one embodiment;

FIGS. 6A and 6B are diagrams illustrating an augmented reality view employing a selection of ranges, according to one embodiment;

FIG. 7 is a diagram illustrating an augmented reality view employing a plurality of viewing windows, according one embodiment;

FIG. 8 is a diagram of the components of an information mapping platform, according to one embodiment;

FIG. 9 is a diagram of the components of user equipment capable of presenting an active search UI element, according to one embodiment;

FIG. 10 is a flowchart of a process for determining the availability of information, according to one embodiment;

FIG. 11 is a time sequence diagram that illustrates a sequence of messages and processes for retrieving and updating availability information, according to one embodiment;

FIG. 12 is a flowchart of a process for presenting a user interface depicting a first person world view of desired information, according to one embodiment;

FIG. 13 is a flowchart of a process for locking an augmented reality user interface at a fixed position, according to one embodiment;

FIG. 14 is diagram of a user interface utilized to present a list of search results for desired information items, according to one embodiment;

FIG. 15 is a diagram of hardware that can be used to implement an embodiment of the invention;

FIG. 16 is a diagram of a chip set that can be used to implement an embodiment of the invention; and

FIG. 17 is a diagram of a mobile terminal (e.g., handset) that can be used to implement an embodiment of the invention.

### DESCRIPTION OF SOME EMBODIMENTS

Examples of a method, apparatus, and computer program for providing an active search user interface element are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

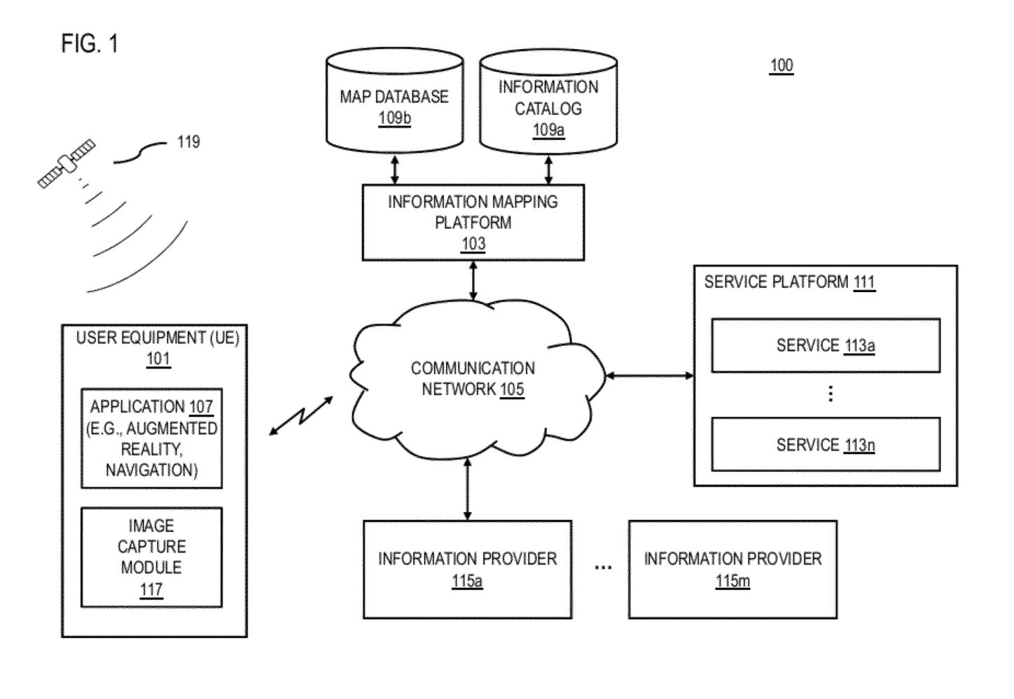

FIG. 1 is a diagram of a system capable of providing an active search user interface element, according to one embodiment. An information item may be desired if it is received by way of an input be it textual, verbal, user selected, etc. The information item may be any item, search item, topic, data point, etc. that may be present in a document, have a corresponding location on a map, or any location that the item could be tied to in space or a virtual world.

Generally, large amounts information may be found within a document, or can be accessed over the Internet, using computers, mobile devices, and other Internet-connected devices. This vast collection can quickly overwhelm the user, thereby making it extremely difficult for the user to identify and access information of interest. In one embodiment, such information may be associated with location information including, for instance, geographical or physical location as well as location within a user interface or document. One conventional approach to presenting results of location-based searches is to highlight or point to their locations in a document or on a map. Another conventional approach is to present search results as a list. However, in either case, these traditional approaches may not be effective in situations where the density of search results correlating to the desired information item or search result is high. More specifically, the high density of information can make arrows, pointers, and/or lists long and uninteresting to a user. Moreover, the user may not find a desired result if the result is buried among many other items. Without an exciting or novel presentation, information that would otherwise appeal to a user might go unnoticed and be missed.

To address the problems described above, a system 100 of FIG. 1 introduces the capability of presenting an active, transforming, single user interface (UI) element that enables a user to: (1) input search parameters or terms to query for desired information, (2) receive directional information where the search results are located within the UI, and (3) view the search result at its correct position with respect to the UI and the underlying map, document, etc. Although various embodiments are described with respect to mapping, augmented reality, virtual reality display (e.g., seeing through the Earth, by pointing a device to locations on the opposite side of the Earth and presenting the locations as if the Earth were transparent), and the like, it is contemplated that the various embodiments of the approach described herein are also applicable to any other content, application, service, etc. that present the search results associated with particular locations with a UI. For example, an imaging application may allow search for the face of a person in a group photo or live video. In this case, the active search element can be used to query for the person and then the same element can be moved or animated to indicate the location of the person in the photo or video.

In one embodiment, the active search UI element can be initially presented at any position within the UI. In another embodiment, the user may decide where to initially put the element to indicate where to start a search. By way of example, the active search UI element includes, at least in part, a search parameter input area and related visualization (e.g., a search magnifying glass icon) to indicate that the UI element is search box or tool. A user can then, for instance, enter search parameters in the input area and then select the icon to initiate the search.

In one embodiment, on initiation of the search, the UI element visualization may change, for example, so that the magnifying glass turns into an arrow to show the location where the searched item/location is with respect to the UI. In addition, the visualization of the search input area can also be changed to indicate that a search is underway and that the input area is not editable. For example, the search input area can be grayed out to indicate that a search is underway. At the same time, the active search UI element can be animated in the UI to indicate a movement towards the direction of the searched item (e.g., where the arrow in the UI element is pointing).

In one embodiment, if the searched item is not in a visible area of the UI (e.g., in an augmented reality (AR) application, the user is not currently pointing towards the area of the search result), the UI element may be changed to indicate a direction to move the visible area of the UI to bring the search result into view. For example, the background or borders of the UI element may change to indicate to the user which way to turn the device (e.g., for AR applications) or which way to scroll the UI. The change may include modifying the background of the UI element to have a scrolling pattern that scrolls in the indicated direction. In addition or alternatively, other indicators may be used to direct the movement of the UI to search result (e.g., arrows, animation, audio instructions, etc.).

In one embodiment, when the UI element reaches the location of the search result in the UI, the UI element stops. For example, if the search result is for a particular city and the UI is displaying a map, the UI element will move from the initial search location to the location of the city within the UI. In this way, the user can easily visualize and connect the search with the location of the search results. In one embodiment, the UI element can transform into another visualization to indicate the location of the search result. For example, the UI element can transform into a city label on reaching the city location. If the search is for a face in a photograph, the UI element can transform into a frame surrounding the location of the face in a UI displaying the photograph. In some embodiments, the user can perform the reverse operation to turn a visual UI element into an active search UI element by, for instance, long pressing on the visual UI element or other selecting a command to initiate the operation.

As noted, it is contemplated that the active search UI elements is applicable to querying for any number of items including, at least in part: (1) any item with a location in the real world or map, e.g., a building, city, country, event, person, terrain feature, geotagged information, time, day, etc.; (2) any item with a location in a document view, e.g., person in a photograph, person in a video, any object in an image, any word in a document, any photograph in a gallery, etc.; and/or (3) any item with a location in an imaginary or virtual world, e.g., location/character in a game, film, book, etc.

In one embodiment, if no result is found, the active search UI element remains at is initial location in the UI and does not turn into a result box or element. In another embodiment, if the a user wants to change the search as the search is being performed or as the UI element is moving, the user can select the box or provide another command or indication.

In yet another embodiment, the UI may support multiple active search elements at the same time. In addition, a single active search UI element may transform into multiple search result elements if there are more than one result of the search present in the UI. In addition or alternatively, the single active search UI element can move from one search result location to another location in a sequential manner. By way of example, the sequential indication may be based on relevance of the search result (e.g., the active search UI element travels to the most relevant result first, then the next most relevant, and so on), proximity to the active search UI element, or any other criteria.

In one embodiment, a search is initiated when the system 100 receives an input from the active search UI element in, for instance, a user equipment 101 and determines available location information based, at least in part, on the input. In one embodiment, the system 100 verifies that the location information is available and conducts a verification process at predetermined intervals (e.g., every 30 seconds, every 5 minutes, etc.) or at specified times to ensure that the location information is up-to-date. Once the location information is verified and availability of the location information is determined, the system 100 generates a user interface to present the location information via the active search UI element as discussed above. By way of example, the location information may indicate: (1) a location of an item that is a result of a search, (2) a location where the information relating to the item was captured, e.g., geo-tagged data, and (3) a location of a provider of the information, or any other data or information that include or are otherwise associated with one or more results of the search. It is also contemplated that the desired information item may be associated with multiple locations.

In another embodiment, the system 100 renders the active search UI element based on the three-dimensional (3D) direction along which a user device is pointed. More specifically, the system 100 utilizes augmented reality (e.g., using live or actual images of a location) or augmented virtual reality (e.g., using 3D models and 3D mapping information) to present a model of an map object (e.g., the Earth), seen in a first person view from the user device's current location so that the locations seen in the view match corresponding physical locations in reality. Although various embodiments are discussed with respect to the Earth as the three-dimensional map object, it is contemplated that the approach described herein is applicable to any map object including any real objects (e.g., a house, road, paper mill, etc.) and/or virtual objects (e.g., planned architectural models, renderings of fictitious objects, game environments, fictional environments, etc.). In yet another embodiment, depending on the location information associated with the search results, the first person view is rendered as though the user would see through a map object (e.g., the Earth) to view the active search UI element moving towards the representation of the desired information. This view (e.g., a transparency effect) can be used, for instance, when the location information of the search results is sufficiently far from the user's location (e.g., the opposite side of the Earth) that the map object (e.g., the Earth) itself would be an obstruction between the user and the location information.

In other words, the view shows the user the location information at a corresponding location on the other side of the map object where the user device is pointed. This view advantageously enables the user to understand how the map object as seen in the generated first person view relates to the physical world. Thus, the user becomes concretely aware of the nature (e.g., the spherical nature of the Earth). For instance, it is noted that although users are generally familiar that the Earth is round, they do not actively consider its meaning in the physical world: that they live on the surface of a spherical planet, and that most of the world is in fact located somewhere below their feet. For instance, if a person living in New York were asked where China is in reality, the person likely would reply with a compass direction (e.g., East of New York) or could not answer accurately at all. It is unlikely that the person would point along the most direct route through the Earth below the person's feet.

This lack of perspective or direction arises partly because traditional location based augmented reality systems lack the possibility to point to and/or search/browse available information (e.g., geolocations, geo-tagged data, information associated with location information, etc.) anywhere on the Earth, including the other side of the world. Unlike the approach described herein, typical augmented reality solutions are suitable only for the range that is physically visible from the user's real physical location. The range can, in fact, be very short due to obstacles such as walls of buildings, and ultimately objects will drop below the horizon in the distance, making distant objects impossible to view in traditional augmented reality systems. Because the first person augmented reality view of the system 100 treats the Earth as if it were transparent, the system 100 does not suffer the same limitations of traditional systems with respect to rendering distant objects.

In another embodiment, the system 100 enables the user to search for available information items by time as well as location. For example, the user can specify a time in the past, present, or future. The system 100 can then search for the availability of location information with respect to the specified period of time and animate the active search UI element to location of the desired information item in the UI based on the specified time. In this way, the user can view what search results are available at any particular time.

As shown in FIG. 1, the user equipment (UE) 101 may retrieve location information and mapping information (e.g., global maps, 3D maps, first person augmented reality views, etc.) from an information mapping platform 103 via a communication network 105. The location information and mapping information can be used by an application 107 on the UE 101 (e.g., an augmented reality application, navigation application, or other location-based application). In the example of FIG. 1, the information mapping platform 103 stores location information in the information catalog 109a and mapping information in the map database 109b. By way of example, location information includes one or more identifiers, metadata, access addresses (e.g., network address such as a Uniform Resource Locator (URL) or an Internet Protocol (IP) address; or a local address such as a file or storage location in a memory of the UE 101), description, or the like associated with any desired information item. In one embodiment, desired information items include any of live media (e.g., streaming broadcasts), stored media (e.g., stored on a network or locally), metadata associated with media, text information, location information of other user devices, mapping data, geo-tagged data (e.g., indicating locations of people, objects, images, etc.), or a combination thereof. The desired information item may be searched for and provided by a service platform 111 which includes one or more services 113a-113n (e.g., music service, mapping service, video service, social networking service, information broadcasting service, etc.), the one or more information providers 115a-115m (e.g., online retailers, public databases, etc.), or any other information source available, or accessible, over the communication network 105.

In certain embodiments, the mapping information and the maps presented to the user may be an augmented reality view, a simulated 3D environment, a two-dimensional map, a document (e.g., a word processing document, an image, a video, etc.), or the like. In certain embodiments, the simulated 3D environment is a 3D model created to approximate the locations of streets, buildings, features, etc. of an area. This model can then be used to render the location from virtually any angle or perspective for display on the UE 101. In some programs (e.g., navigation application 107), the 3D model or environment enables, for instance, the navigation application 107 to animate movement through the 3D environment to provide a more dynamic and potentially more useful or interesting mapping display to the user. In one embodiment, structures are stored using simple objects (e.g., three dimensional models describing the dimensions of the structures). Further, more complex objects may be utilized to represent structures and other objects within the 3D representation. Complex objects may include multiple smaller or simple objects dividing the complex objects into portions or elements. To create the 3D model, object information can be collected from various databases as well as data entry methods such as processing images associated with location stamps to determine structures and other objects in the 3D model.

In addition or alternatively, the mapping information may be displayed using other user interfaces such as audio interfaces, haptic feedback, and other sensory interfaces. For example, in an audio presentation of the mapping information, the approximate locations of streets, buildings, features, points of interest, desired information items, etc. can be read aloud by a voice synthesizer executing on the UE 101.

Additionally or alternatively, in certain embodiments, an image capture module 117 of the UE 101 may be utilized in conjunction with the application 107 to present location information (e.g., mapping and navigation information) to the user. The user may be presented with an augmented reality interface associated with the application 107 and/or the information mapping platform allowing 3D objects or other representations of desired information and related information to be superimposed onto an image of a physical environment on the UE 101. In certain embodiments, the user interface may display a hybrid physical and virtual environment where 3D objects from the map database 109 are placed superimposed on top of a physical image.

By way of example, the UE 101 may execute the application 107 to query for a desired information item and/or mapping information from the information mapping platform 103 or other component of the network 105. As mentioned above, the application 107 and information mapping platform 103 receive access information about a desired information item, periodically determines the availability of the desired information item based on the access information, and then presents a unique visualization of the active search UI element that moves within the UI to indicate the one or more search results.

Moreover, map information stored in the map database 109b may be created from 3D models of real-world buildings and other sites. As such, objects can be associated with real world locations (e.g., based on location coordinates such as global positioning system (GPS) coordinates). In certain embodiments, the UE 101 may utilize GPS satellites 119 to determine the location of the UE 101 to utilize the information mapping functions of the information mapping platform 103 and/or the application 107. The map information may include a 3D model (e.g., a complex 3D model) of objects and structures in a physical environment (e.g., buildings) made up of a number of separate but adjoined simple 3D shapes such as polygons. Conventional approaches of 3D modeling include the ability to access and transform each polygon in size and shape separately from the other polygons that form the complete 3D model of the object.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the UE 101 can be a device that simulates or provides a virtual telescope-like function. This type of UE 101 can be, for instance, mounted in a public place (e.g., a shopping center, hotel, etc.) to enable users to view information presented as described herein.

By way of example, the UE 101, and information mapping platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the information mapping platform 103 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

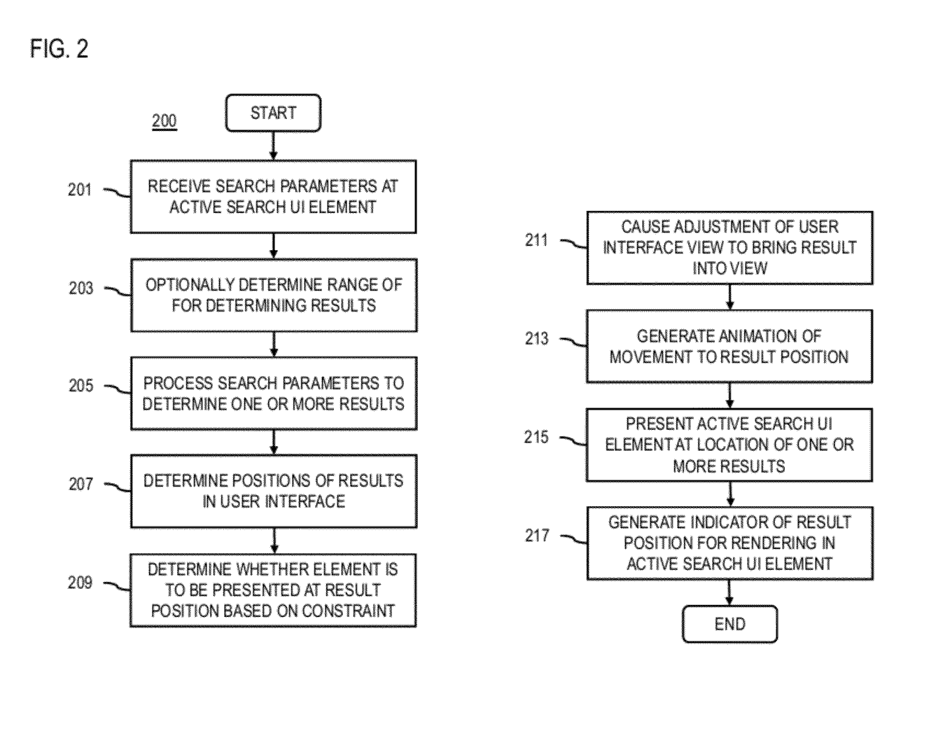

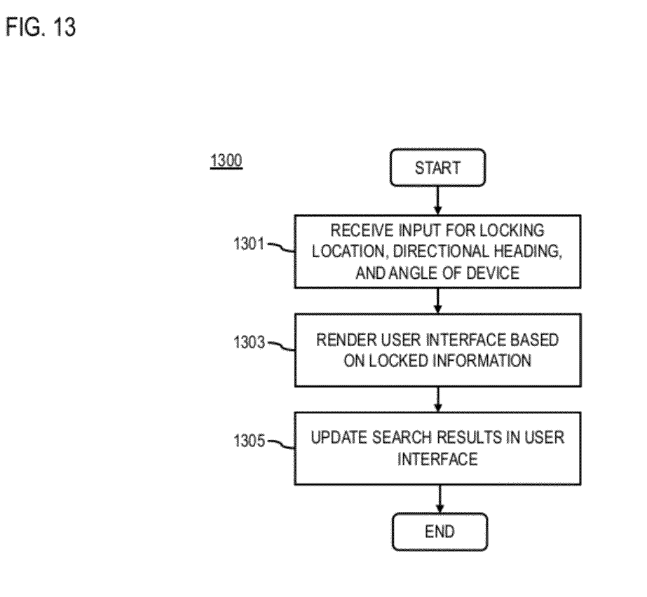

FIG. 2 is a flowchart of a process for providing an active search user interface element, according to one embodiment. In one embodiment, the runtime module 905 performs the process 200 and is implemented in, for instance, a chip set including a processor and a memory as shown FIG. 13. In certain embodiments, the information mapping platform 103 may perform some or all of the steps of the process 1000 and communicate with the UE 101 using a client server interface. The UE 101 may activate an application 107 to utilize information mapping services of the information mapping platform 103. Moreover, the application 107 may execute upon the runtime module 905.

In step 201, the runtime module 905 receives one or more search parameters at an active search element of a user interface, the element presented at an initial position within the user interface. In one embodiment, the user interface is at least one of a map, a document, an image, a game, an augmented reality application, and a virtual reality application that includes the element. Next, the runtime module 905 optionally determines a range of the one or more search parameters based on receiving a direction from the element, wherein the one or more search results are further based, at least in part, on the range (step 203). In one embodiment, the active search UI element further comprises a switch to change the range between at least two default values. The range represents, for instance, the distance for the search location (e.g., a radius) over which to conduct the search. For example, one range may specify a smaller search radius of 20 miles (e.g., to find only local results); and another range may specify a larger search radius of 100 miles. In searches not based on distance (e.g., which search for words in a document or objects within a photograph), the range may be specified in other units (e.g., within 20 words, within 2 paragraphs, within 2 objects, etc.).

Next, the runtime module 905 processes and/or facilitates a processing of the one or more search parameters to determine one or more search results (step 205). By way of example, the search parameters may include, at least in part, subject terms, one or more locations, one or more temporal parameters (e.g., time, date, season, etc.), and the like. The runtime module 905 then determines one or more other positions within the user interface based, at least in part, on the one or more search results (step 207). These positions represent locations of the one or more results within the user interface (e.g., location on a map or document).

In some embodiments, the runtime module 905 determines whether the element is to be presented on the user interface at the one or more other positions based on a constraint (step 209). For example, the constraint may be based, at least in part, on a viewable display area of the device that can determine the level of detail, zoom, and UI area (e.g., a map area or document page) that can be displayed at a given time. This constraint may limit, for instance, the number, range, extent, etc. of search results and their locations that can be displayed at one time. If the viewing area cannot be adjusted (e.g., the user can not rotate the UE 101 to the direction of the results), then the runtime module 905 causes, at least in part, a presentation of at least one direction indicator to illustrate a direction of at least one of the one or more positions that is determined to not be presented on the user interface. If the device can be rotated or the view can be scrolled, then the runtime module 905 causes, at least in part, an adjustment of the user interface so that the element presented at the one or more other positions that are in the direction indicated by the direction indicator are presented on the user interface (step 211).

The runtime module 905 also determines to generate an animation depicting, at least in part, a movement of the element from the position to the at least one of the one or more other positions (step 213). As noted, the animation may indicate a movement from the initial position of the active search UI element to one or more of the results (e.g., sequential animation from one result to the next, or animation showing the UI element dividing and then moving to the multiple results). Following the animation, the runtime module 905 causes the at least in part, presentation of the element at at least one of the one or more other positions (e.g., corresponding to the one or more search results) (step 215).

In addition or alternatively, the runtime module 905 can determine to generate an indicator based, at least in part, on (a) the position of the at least one element with respect to the one or more other positions, (b) a function of the at least one element, (c) a status of the function, or (d) a combination thereof for presentation of the indicator in the least one element (step 217). For example, the indicator may point to the one or more results. In addition, the function of the least one element may include performing the search or query, moving to the one or more result location, etc. In this case, the indicator can provide a status (e.g., a progress bar) towards completing the function.

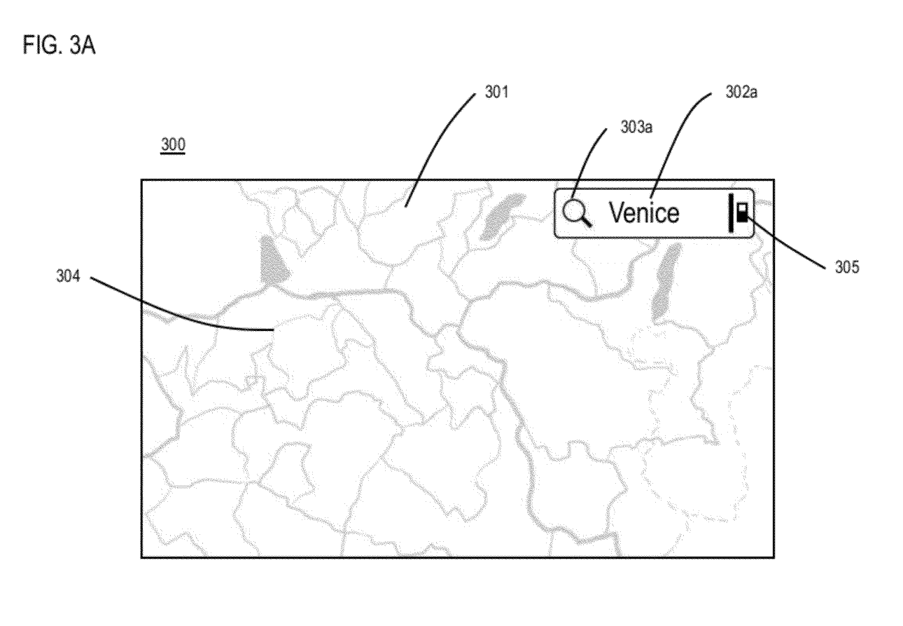

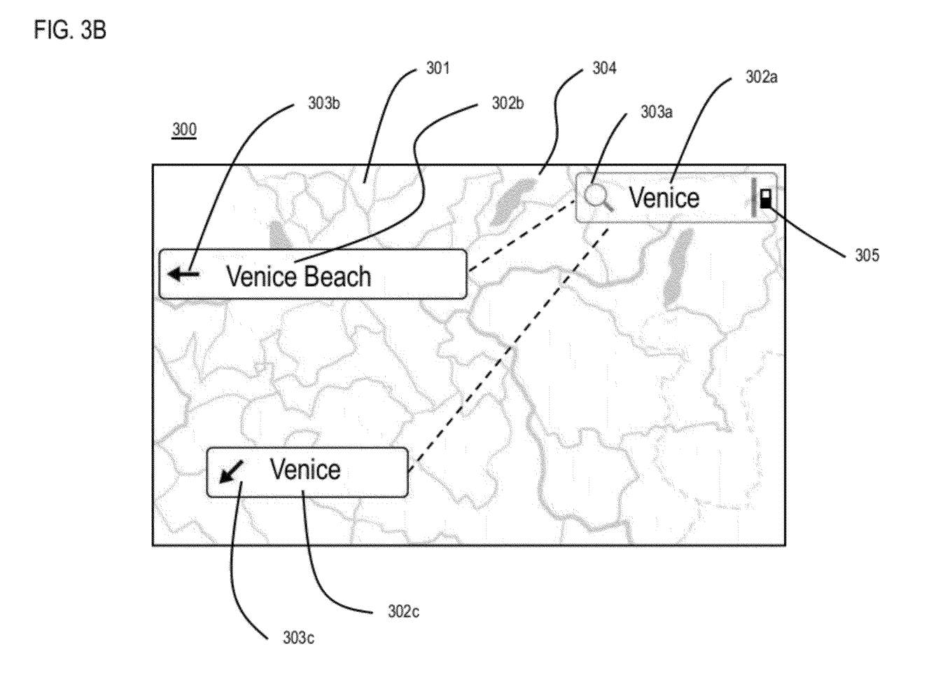

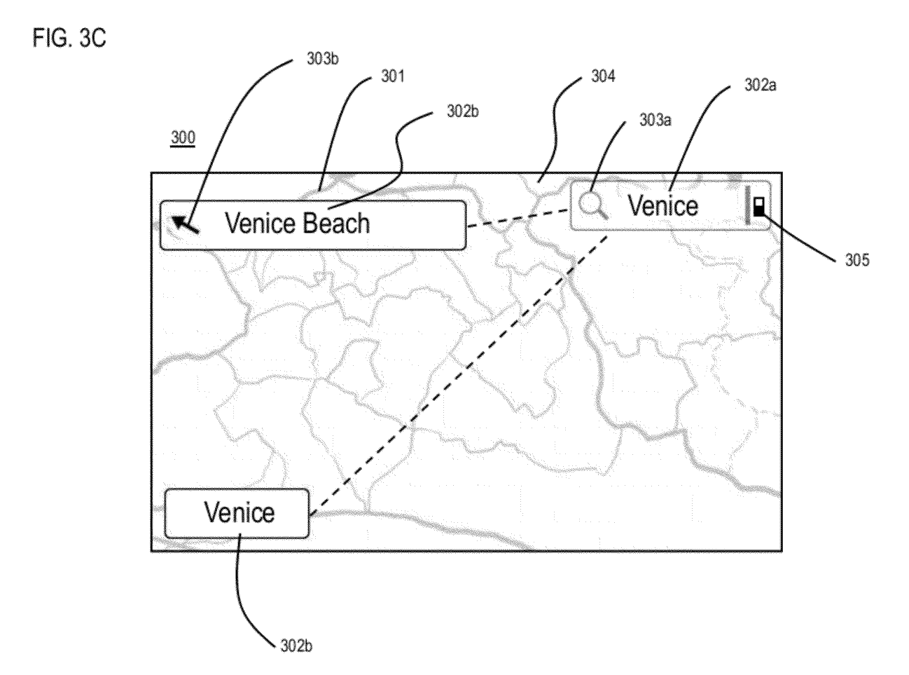

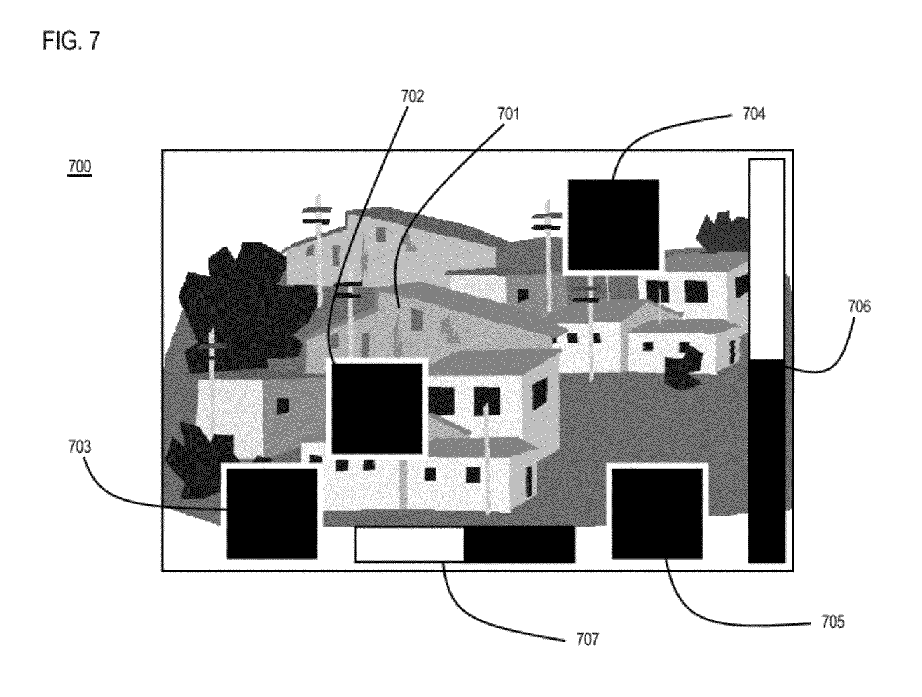

FIGS. 3A-3C are diagrams that illustrate example user interfaces used in the process of FIG. 2, according to various embodiments. FIG. 3Aa depicts a user device 300 having a user interface 301. The user interface, in this exemplary embodiment, illustrates a map 304. The map 304 may be limited to a default range around the location of the user device 300, or around a selected starting position for viewing. The range, however, may be adjustable to expand or reduce the scope of the view available on the user interface 301 around any location. The user interface 301 has a search box, or element, 302a positioned in the upper right corner of the user interface 301. The search box 302a may be fixed or be moveable to any location on the user interface 301. The search box 302a may also be rotatable, or its general shape may be changeable as well. The search box 302a has an indicator 303a that indicates a function that may be acceptable by the user device 300 if data is input into the search box 302a. In this example, the indicator 303a is a magnifying glass designating a search function. A user may input a desired information item such as “Venice” into the box 302a and begin a search function for the desired information item. The search box may also have a range selection element 305 which operates like the range selection element discussed below regarding FIG. 7 for the example viewing windows 702-705.

FIG. 3B is a diagram illustrating example search results for the desired information item specified in the search box 302a. The user interface 301 is populated with search results by moving, or replicating the search box 302a as additional search boxes 302b and 302c. The search boxes 302b and 302c appear at or near the found location information (e.g., locations of the search results) for the desired information item. The movement of the additional search boxes 302b and 302c may be animated to illustrate the apparent movement between the search box 302a and the found location information, or they may simply appear at the found location information when the user interface 301 is refreshed. The search boxes 302b and 302c also designate a direction of the location of the desired information item by changing the indicator 303a to arrows illustrated by features 303b and 303c. In FIG. 3b, the viewable range of the user interface 301 is limited. So, indicator 303b illustrates that a search result that correlates to the desired search item “Venice” may be viewed if the user interface 301 is adjusted to reveal results in the direction the indicator 303b points.

In FIG. 3B, search box 302a is grayed out or faded to illustrate that the search is in progress. However, the user may select any of the search boxes 302a-302c to conduct an additional search to hone in on more specific information, even while a search is in progress.

FIG. 3C is a diagram that illustrates the user interface 301 on a user device 300. In this example, the movement of the search boxes that illustrate the location information of the desired information item is substantially same as that illustrated in FIG. 3B, but search box 302b does not have an indicator. The search box 302b, in this case, appears directly on top of the location of the desired information item, but may also be editable to conduct an additional search. If no search results are found for the desired information item, then the search box 302a will not move, and no search results will be presented. However, the search may be modified through user preferences to illustrate items that may be of relevance even though the results do not exactly match the search item for the desired information item.

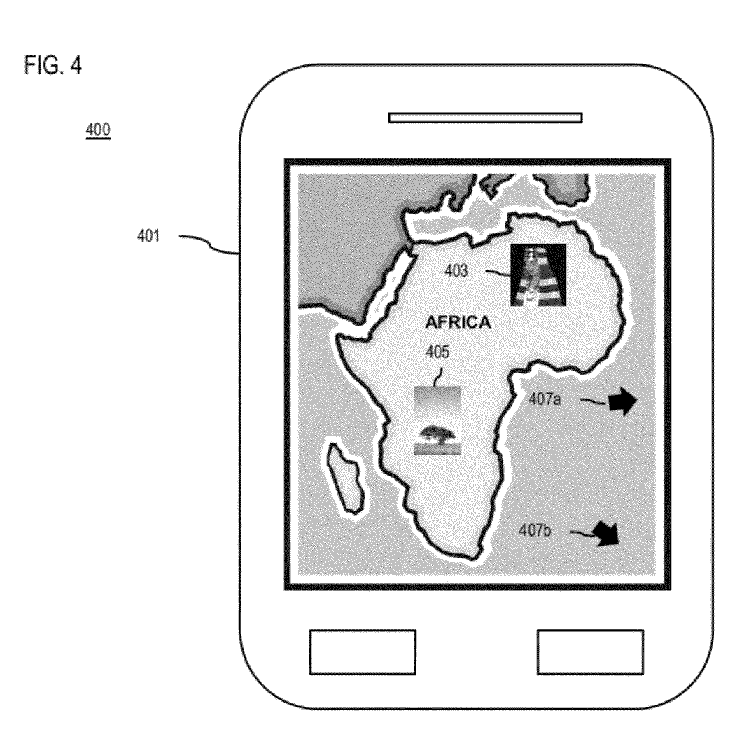

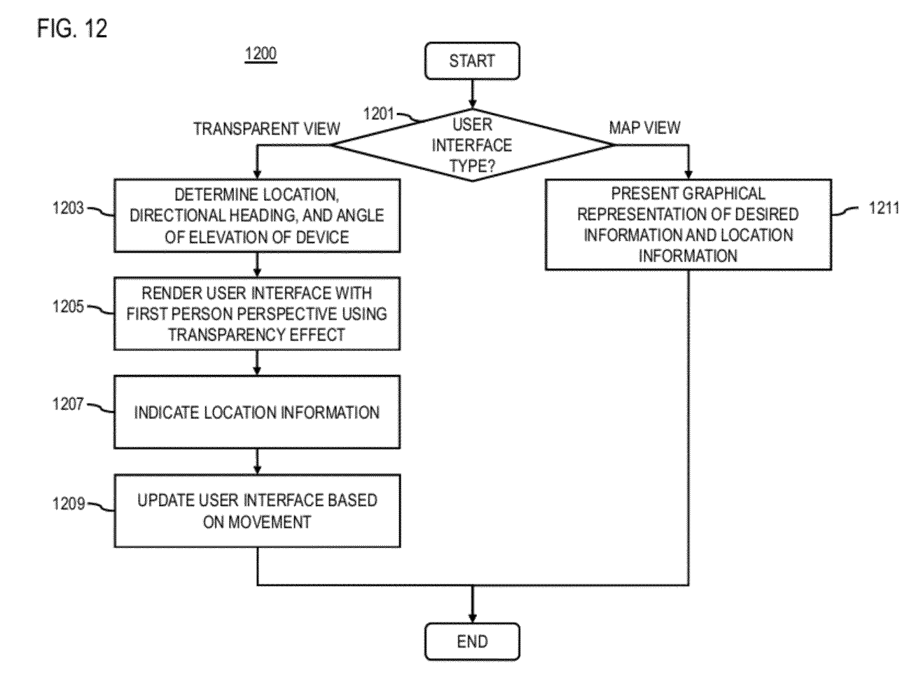

FIG. 4 is a diagram of a user interface utilized to present an augmented reality view of the active search UI element and its search results, according to one embodiment. The user interface 400 depicts an augmented reality display of information using the transparency effect described below with respect to FIGS. 12 and 13. As shown, the user interface 400 is displayed on a mobile device 401 that includes sensors for determining viewpoint parameters such as location, direction heading, and angle of elevation. In this example, the mobile device 401 is pointed towards the Earth in the direction of Africa. Because the viewpoint or perspective is a view through the Earth to the opposite surface (e.g., in essence from inside the Earth), Africa is shown as a mirror image.

As the mobile device 401 pans around, the augmented reality user interface displays information items (e.g., information items 403 and 405) that are associated with the location in the user interface 400 displayed based on the viewpoint of the mobile device 401. The number of information items displayed is limited to prevent obscuring the map. In one embodiment, information items may be animated to appear and disappear periodically to display additional information. This animation also provides for a more dynamic and interesting display that may pique the user's interest in the information. Additionally, directional arrows (e.g., arrows 407a and 407b) may point in the direction that the mobile device 401 can be moved, or the user interface can be adjusted, to view additional or related information including related search results. These arrows 407a and 407b may also indicate the direction of information items that meet user search criteria.

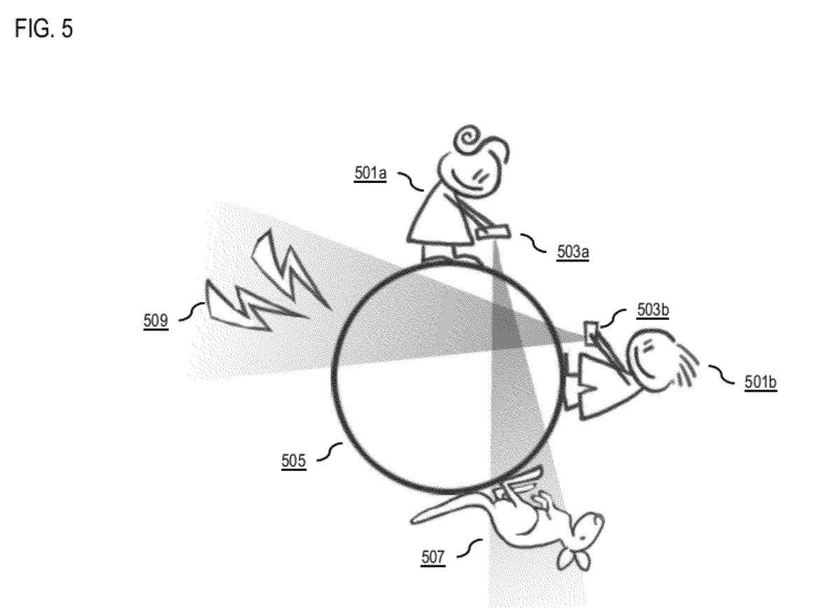

FIG. 5 is a diagram illustrating an augmented reality view employing a transparency effect, according to one embodiment. As shown, a user 501a points a user device 503a towards the Earth 505 to view an augmented reality display of an information item 507 (e.g., a location of a kangaroo) located on the opposite side of the Earth 505. Similarly, a user 501b points a user device 503b through Earth 505 to view an information item 509 (e.g., location of a lightning storm) on the opposite side of the Earth 505. In both cases, the augmented reality view renders the Earth 505 as if the Earth 505 were transparent by showing a representation of the respective information items 507 and 509 unhindered by any obstruction in the graphical user interfaces of the respective user devices 503a and 503b. As described previously, rendering a transparent Earth 505 effect provides for a unique and interesting view of the active search UI element and its search results.

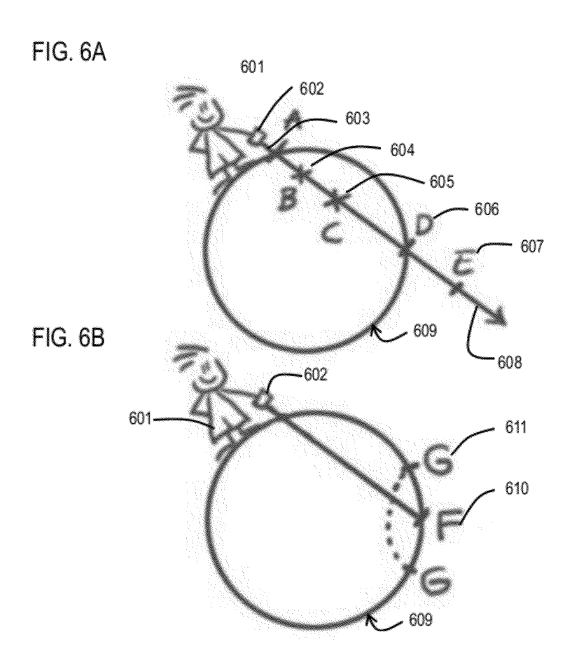

FIG. 6A is a diagram illustrating an augmented reality view employing a transparency effect according to one embodiment. As shown, a user 601 points a user device 602 towards the Earth 609 in a direction 608. Features 603, 604, 605, 606 and 607 illustrate exemplary ranges that the user 601 may select on the user device 602 that limit the view of the desired information items with respect to a global position of the user 601. For instance, the distance from the user 601 to position 604 is less than the distance from the user 601 to the position 606. The direction 608 may be any direction that the user 601 may select, and the selectable distances 601-607 are merely examples and are not limited to the depicted number of positions or the depicted positions in space.

By way of example, the concept of the viewable range may be described in the context of headlights for an automobile. For example, the user 601 may select a short range head light that limits the distance of his view, but allows for greater detail within the view, and includes very little interference. Alternatively, the user may select a longer range head light that allows the distance of the user's view to be increased, but the detail that may be seen in reduced, or the detail may be the same, even though what is viewed is at a distance that is farther away from the user. In this context, if the user 601 selects a range that extends along the direction 608 to position 606, the user may see content inside the Earth 609 which may or may not be rendered in the user device 602 as side walls of a tunnel.

FIG. 6B is a diagram illustrating an augmented reality view employing a transparency effect according to one embodiment. As shown, a user 601 points a user device 602 towards the Earth 609 in a direction 608. Feature 610 illustrates a position that designates an extent of a selected range of view, and feature 611 illustrates a selected radial distance that is variable around the selected position 610 within with the user 601 may limit or expand the scope of his view. For example, the radial distance could be varied to range between 0 and 100 km around the position 610. However, the variable range may be any amount greater than or less than the exemplary variable radial range around the selected position 610.

FIG. 7 is a diagram illustrating a user interface 701 of a user device 700 that features multiple viewing windows 702, 703, 704 and 705 through which a user may view desired information items, according to one embodiment. The viewing windows 702, 703, 704 and 705 may be singularly controlled by a single range selection element 706, or individually controlled by a plurality of range selection elements to vary the range of their view by toggling a range selection element 706. The range selection element 706 may be positioned on a side of the user interface 701, or integrated into any of the exemplary viewing windows 702-705, or may be fixed or moveable anywhere on the user interface 701. The range selection element 706 may simply be an on/off switch to select between particular default ranges, e.g. long or short, or it may be a slider, dial or other means that a user may indicate what the desired range of view should be. The selected range may also be set for a detailed or specific value such as 1000 km from the user device 700 in any direction inside or outside of the Earth. The selected range could also be, for example a measurement between selected variables to enable a view from a starting at a position 200 km away from the user device to a position 900 to 2000 km from the user device 700. In other words, the selected range could have any start or stop point in any direction from the user device 700. The selected range could also have a selected starting position that is other than the position of the user device 700. In various applications, the selected range could apply to other planets or any object in space, or imaginary spaces such as a space or world of a video game.

As discussed above, the range selection element 706 may be a single element or a plurality of elements that individually control a plurality of viewing windows 702-705. A transparency selection element 707 may also be presented in a fixed or moveable position on the user interface 701. The transparency selection element 707, like the range selection element 706, may be a single element or a plurality of elements that globally controls, or individually controls, any viewing window presented on the user interface 701. For example, in a case when multiple viewing windows 702-705 are present on the user interface 701, viewing window 702 may have a greater transparency and/or range of view than viewing window 703. Viewing window 704 may have its range feature turned off, while viewing window 705 may have a reduced range compared to the other viewing windows 702-704. In this example, viewing window 705 may also have a minimized transparency compared to the other viewing windows 702-704.

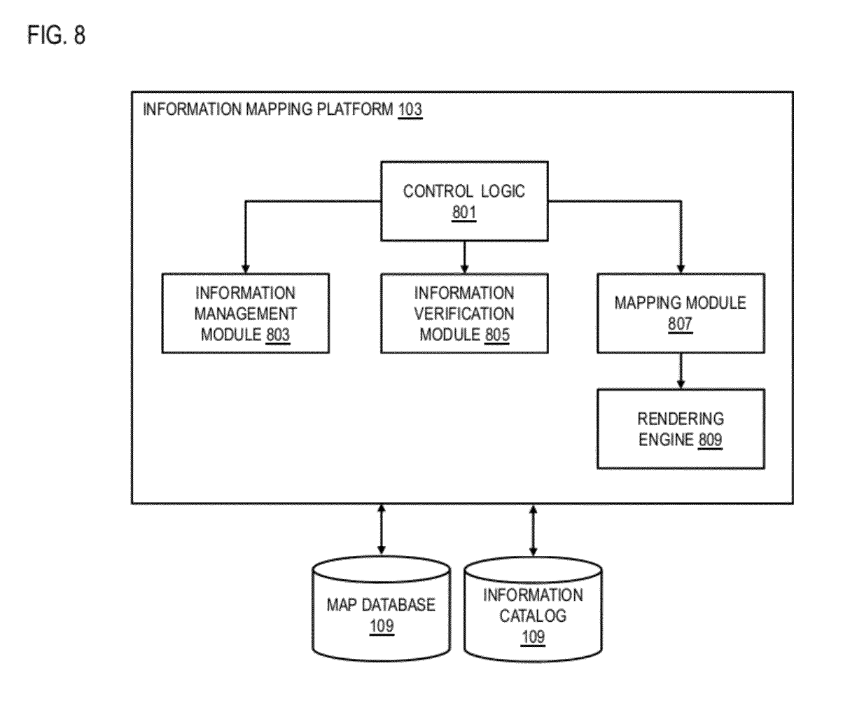

FIG. 8 is a diagram of the components of an information mapping platform, according to one embodiment. By way of example, the information mapping platform 103 includes one or more components for presenting a user interface include, at least in part, the active search UI element and/or related search results. It is contemplated that the functions of these components may be combined in one or more components or performed by other components of equivalent functionality. In this embodiment, the information mapping platform 103 includes at least a control logic 801 which executes at least one algorithm for executing functions of the information mapping platform 103. For example, the control logic 801 interacts with an information management module 803 to receive access addresses corresponding to one or more information items. The access addresses may be received from the service platform 111, the services 113a-113n, the information providers 115a-115m, other like components, or a combination thereof. It is also contemplated that the user or another party authorized by the user may manually enter an access address of an information item. In one embodiment, the information management module 803 may create a location information catalog listing all location information items and associated access addresses provided to the information management module 803. In certain embodiments, the information catalog may include additional descriptive information and other metadata describing the information.

Next, the control logic interacts with the information verification module 805 to determine the availability or information about the availability of location information about the desired information item. More specifically, the information verification module 805 verifies the status of a given information item by accessing the information at the corresponding access address. By way of example, the status includes: (1) whether the server hosting the information's access address is responding with the requested information; (2) whether there are any limitations or exclusivity restrictions on the desired information item (e.g., does the information require authentication or registration before access); (3) whether the desired information item is available for a certain period (e.g., only for a specific duration or only at specific times); and other like information. In one embodiment, the information verification module 805 can verify a particular information item before the information management module 803 adds the information item and related information to the information catalog. Alternatively, the information verification module 805 can perform the verification process continuously (e.g., a predetermined or fixed interval) by scanning the entire information catalog and updating the availability information accordingly.

Because the available information can take many forms (e.g., plain text, live video feeds, photographs, audio files, etc.) and can be delivered using any number means (e.g., streaming media, downloaded media, spontaneously created media, etc.), the information verification module 805 includes one or more sub-modules or application programming interfaces (APIs) (not pictured) for receiving and/or detecting the information in its native format or for converting the information to a media format compatible with the information mapping platform 103. In other embodiments, the information verification module 805 may initiate a download or installation of the components (e.g., codecs, player applications, etc.) needed to verify the location information.

After verification, the control logic 801 interacts with the mapping module 807 to correlate the location information associated with the one or more desired information items with respective locations on a map based, at least in part, on the search process using the active search UI element. In one embodiment, the location information may include coordinates (e.g., GPS coordinates) or other indicators (e.g., longitude and latitude information) that can be associated with an existing map. For example, the location information may be extracted or derived from any geo-tagged data (e.g., geo-tagged automatically or manually by the user) such as photographs, videos, audio recordings, and the like. This location information (e.g., GPS or other coordinates associated data) generally is recorded with the data when the data is captured or recorded. The mapping module 807 can then perform recognition (e.g., facial recognition, audio recognition, object recognition, etc.) on the data to identify people, locations, other subjects, or related information in the data. The identified people, locations, etc. can then be associated with the extracted location information. In addition or alternatively, it is contemplated that the location information or geo-tagged data could also be created by the mapping module 807 by deriving the location from associated metadata (e.g., media titles, tags, and comments). More specifically, the mapping module 807 can parse the metadata for any terms that indicate association with a particular location. For instance, a family vacation photograph may be tagged with a description of “Paris Vacation.” The mapping module 807 can parse “Paris Vacation” using a natural language model to associate the photograph with Paris, France even though the photograph does not include any traditional location information (e.g., GPS coordinates).

The mapping module 807 then interacts with the rendering engine 809 to present the location information of the desired information, and other information related to the desired information using any type of visual user interface (e.g., augmented reality view, 3D maps, etc.), audio user interface, tactile or tangible user interface (e.g., haptic feedback), or any possible user interface or combination of user interface types.

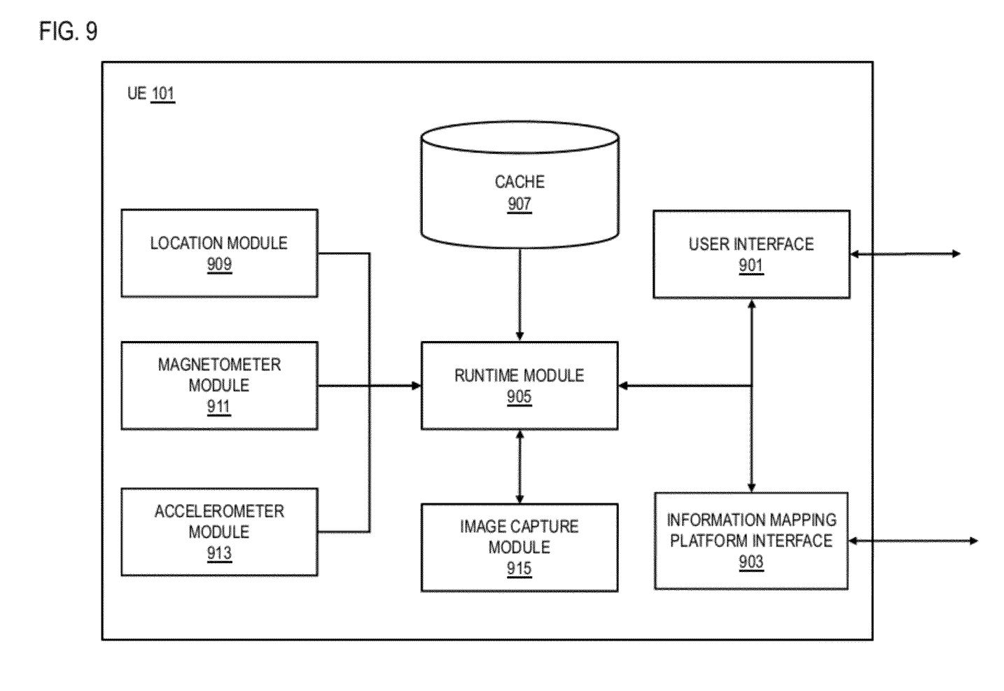

FIG. 9 is a diagram of the components of user equipment capable of presenting an active search UI element, according to one embodiment. By way of example, the UE 101 includes one or more components for presenting desired information and location information accessible over the communication network 105 via the active search UI element. It is contemplated that the functions of these components may be combined in one or more components or performed by other components of equivalent functionality. In this embodiment, the UE 101 includes a user interface 901 to present information and receive input, an information mapping platform interface 903 to retrieve information and mapping information from the information mapping platform 103, a runtime module 905, a cache 907 to locally store information and mapping information, a location module 909 to determine a location of the UE 101, a magnetometer module 911 to determine horizontal orientation or directional heading (e.g., a compass heading) of the UE 101, an accelerometer module 913 to determine vertical orientation or an angle of elevation of the UE 101, and an image capture module 117.

The active search UI element, related results, and/or mapping information may be presented to the user via the user interface 901, which may include various methods of communication. For example, the user interface 901 can have outputs including a visual component (e.g., a screen), an audio component (e.g., a verbal instructions), a physical component (e.g., vibrations), and other methods of communication. User inputs can include a touch-screen interface, microphone, camera, a scroll-and-click interface, a button interface, etc. Further, the user may input a request to start an application 107 (e.g., a mapping or augmented reality application) and utilize the user interface 901 to receive information and mapping information. Through the user interface 901, the user may request different types of information items, mapping, or location information to be presented. Further, the user may be presented with 3D or augmented reality representations of particular locations and related objects (e.g., buildings, terrain features, POIs, etc. at the particular location) as part of a graphical user interface on a screen of the UE 101.

The information mapping platform interface 903 is used by the runtime module 905 to communicate with the information mapping platform 103. In some embodiments, the interface is used to fetch information items, mapping, and or location information from the information mapping platform 103, service platform 111, and/or information providers 115a-115m. The UE 101 may utilize requests in a client server format to retrieve the information items and mapping information. Moreover, the UE 101 may specify location information and/or orientation information in the request to retrieve the information items and mapping information. The location module 909, magnetometer module 911, accelerometer module 913, and image capture module 117 may be utilized to determine location and/or orientation information used in determining along which direction the UE 101 is pointed so that desired information and mapping information corresponding to the pointed direction can be retrieved. Further, this information and mapping information may be stored in the cache 907 to be utilized in presenting a world view of desired information at the UE 101.

In one embodiment, the location module 909 can determine a user's location. The user's location can be determined by a triangulation system such as a GPS, assisted GPS (A-GPS) A-GPS, Cell of Origin, wireless local area network triangulation, or other location extrapolation technologies. Standard GPS and A-GPS systems can use satellites 119 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 909 may also utilize multiple technologies to detect the location of the UE 101. GPS coordinates can provide finer detail as to the location of the UE 101. As previously noted, the location module 909 may be utilized to determine location coordinates for use by the application 107 and/or the information mapping platform 103.

The magnetometer module 911 can include an instrument that can measure the strength and/or direction of a magnetic field. Using the same approach as a compass, the magnetometer is capable of determining the directional heading of a UE 101 using the magnetic field of the Earth. The front of the image capture device (e.g., a digital camera) (or another reference point on the UE 101) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is utilized to determine the orientation of the user. This directional information may be correlated with the location information of the UE 101 to determine where (e.g., at which geographic feature or object) the UE 101 is pointing towards. This information may be utilized to select a first person view to render desired information and mapping information.

Further, the accelerometer module 913 may include an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 913 can determine the angle the UE 101 is pointed as compared to Earth's gravity. In one embodiment, vertical directional data obtained from an accelerometer is used to determine the angle of elevation or tilt angle at which the UE 101 is pointing. This information in conjunction with the magnetometer information and location information may be utilized to determine a viewpoint to provide desired information and mapping information to the user. As such, this information may be utilized in selecting available information items to present navigational information to the user. Moreover, the combined information may be utilized to determine portions of a particular 3D map or augmented reality view that may interest the user. In one embodiment, if the location information associated with one or more available information items does not correspond to the viewpoint (e.g., is not visible in the selected viewpoint), one or more indicators (e.g., arrows or pointers) may be shown on the user interface to indicate the direction towards the location of the information items.

In another embodiment, the user may manually input any one or more of the location, directional heading, and tilt angle to specify a viewpoint for displaying the user interface on the UE 101 instead of determining the viewpoint from the sensors. In this way, the user may select a “virtual viewpoint” to be a place other than the current location and pointing direction of the UE 101.

Images for supporting a graphical user interface can be captured using an image capture module 117. An image capture module 117 may include a camera, a video camera, a combination thereof, etc. In one embodiment, visual media is captured in the form of an image or a series of images. The image capture module 117 can obtain the image from a camera and associate the image with location information, magnetometer information, accelerometer information, or a combination thereof. As previously noted, this combination of information may be utilized to determine the viewpoint of the user by combining the location of the user, horizontal orientation information of the user, and vertical orientation information of the user. This information may be utilized to retrieve a desired information item and mapping information from the map cache 907 or the mapping platform 103. In certain embodiments, the cache 907 includes all or a portion the information in the information catalog 109a and the map database 109b.

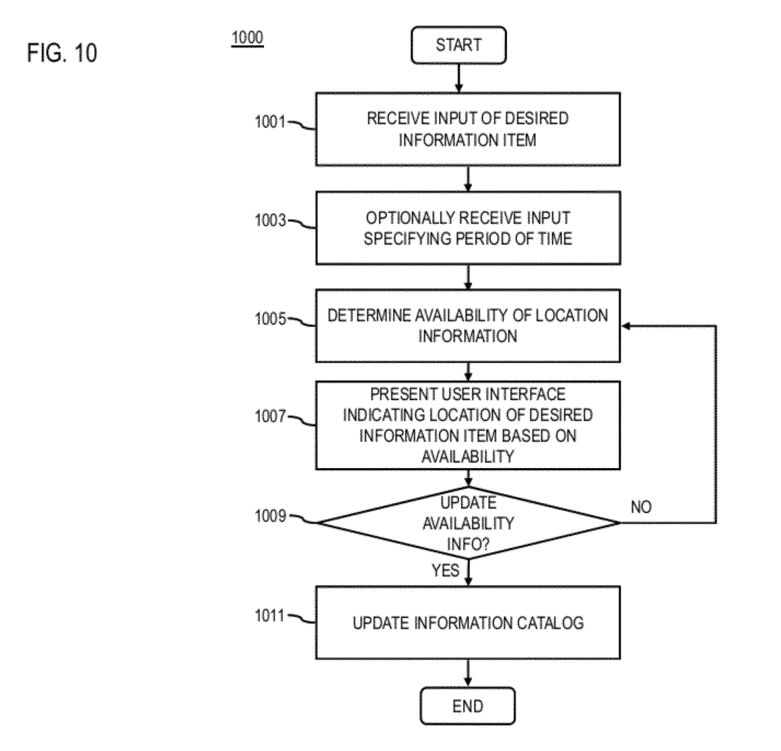

FIG. 10 is a flowchart of a process for determining the availability of information, according to one embodiment. In one embodiment, the runtime module 905 performs the process 1000 and is implemented in, for instance, a chip set including a processor and a memory as shown FIG. 13. In certain embodiments, the information mapping platform 103 may perform some or all of the steps of the process 1000 and communicate with the UE 101 using a client server interface. The UE 101 may activate an application 107 to utilize information mapping services of the information mapping platform 103. Moreover, the application 107 may execute upon the runtime module 905.

In step 1001, the runtime module 905 receives an input of a desired information item via, for instance, the active search UI element. By way of example, the one or more information items and related data may comprise one or more of: (1) media information (e.g., live or stored media, streaming media, web cam feeds, photographs, metadata related to the media information, metadata related to the location information of the media information, etc., or a combination thereof); (2) mapping information (e.g., any available map data); (3) text information (e.g., descriptive labels such as “Venice, Italy”); (4) location information of other users (e.g., friends, coworkers, etc.) and associated avatars, photographs, text, etc.; (5) time of day (e.g., night-time regions can be visualized in darker colors, or working hours regions can be presented differently than non-working hour regions); and (6) natural phenomenon (e.g., ocean currents, hurricanes, environmental conditions, other weather events. It is contemplated that information and other related data are not limited to the above listed categories.

In step 1003, the runtime module 905 may optionally receive input from the UE 101 for specifying a time period in the past, present, or future that is associated with the one or more information items. By enabling specification of a time period, the approach described herein enables the user to navigate desired information using both location and time. In one embodiment, the default time for viewing the information and mapping information is the present. If a time period is provided, the runtime module will determine availability of location information for the one or more information items based on the specified time (step 1005). As mentioned previously, to determine availability of information items, the runtime module 905 analyses whether the access address (e.g., a URL for Internet based information or a file storage location for locally stored information) provides active information corresponding to the one or more desired information item.

As part of the availability determination process, the runtime module 905 may also determine whether the access to the information item is limited or exclusive. That is, the runtime module 905 can determine whether there are additional steps or restrictions (e.g., registration, payment, authorization, etc.) that have to be performed before access to a particular information item is granted. The additional limitations or restrictions can be noted and stored in the information catalog 109a.

The runtime module 905 then presents the determined available location information in a user interface on the UE 101 based on the location information (step 1007). For example, the information can be presented on a map with representations of each information item placed according to the associated location information. If a desired information item originates from Paris, France, the information can be depicted as a thumbnail overlaid on the user interface map at the location corresponding to Paris. As discussed, the user interface may be a graphical user interface. In addition or alternatively, the user interface may be an audio or tactile interface. In one embodiment, the runtime module 905 presents only those information items that are available at the specified time and are not associated with any limitations or exclusive restrictions. This embodiment provides a user experience in which users can simply select from the presented information items and be assured that the selected item will be available with a selection click. In other embodiments, the runtime module 905 may present all available information and differentiate the presentation of available information with a click versus information associated with additional limitations or restrictions. In yet another embodiment, the runtime module 905 may display all evaluated information and differentiate the presentation of available and unavailable information and then differentiate within the available information the information items that are available with a click and those available with additional limitations. The specific types of presentations can be specified by the user, information provider 115, network operator, service platform 111, or a combination thereof.

Next, the runtime module determines whether to periodically update the availability information (step 1009). If the runtime module 905 has been configured for periodic updates, the process 1000 returns to step 1005 and repeats the availability determination step. The frequency of updating may be specified the user, information provider 115, etc. as described above. In this way, the runtime module 905 can present the most up-to-date availability information to the user. The availability information is then used to update the information catalog 109a (step 1011) for subsequent access and distribution to over the communication network 105.

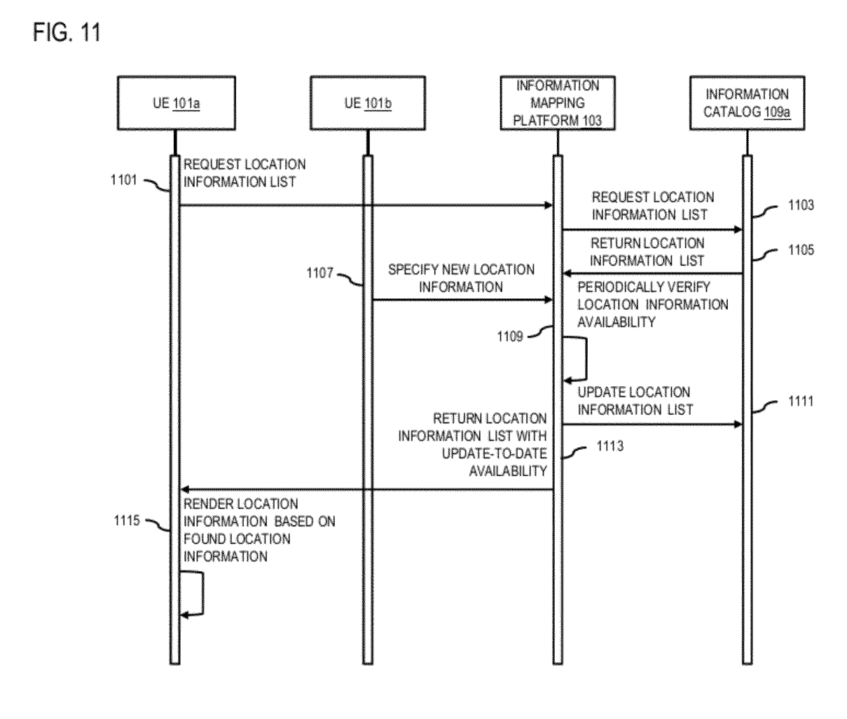

FIG. 11 is a time sequence diagram that illustrates a sequence of messages and processes for retrieving and updating availability information, according to one embodiment. A network process on the network is represented by a shaded vertical box. A message passed from one process to another is represented by horizontal arrows. A step performed by a process is indicated by the text. The network processes represented in FIG. 11 are a UE 101a, a UE 101b, an information mapping platform 103, and an information catalog 109a.

At 1101, the UE 101a transmits a request to the information mapping platform 103 for a list of available location information determined per the approach described herein. In one embodiment, the request may include filters which enable the UE 101a to select what kind of location information should be included in the requested location information list. For example, the request may seek location information related to one more places marked as places that are of particular interest to a user of the UE 101a. The request may also define criteria for location information of interest to the user. On receipt of the request, the information mapping platform 103 applies the filters and criteria to request a location information list from the information catalog 109a (at 1103). The information catalog 109a completes the request and returns the information list to the information mapping platform 103 (at 1105).

In the meantime, the UE 101b accesses the information mapping platform 103 to specify new location information to add to the information list (at 1107). To specify the new information, the UE 101b may submit an access address (e.g., a URL) of the new location information for evaluation by the information mapping platform 103. Either in response to the new location information submission or as part of a periodic updating process (if so configured), the information mapping platform 103 verifies the new submission (at 1109) and updates the information list for the information catalog 109a (at 1111) based on the verification. At the same time, the information mapping platform 103 evaluates whether the new location information passes the filter or satisfies the criteria applied by the UE 101a and transmits the updated location information list to the UE 101a (at 1113). The UE 101a is then assured of having an up-to-date location information list specific to the applied filters and criteria. In some embodiments, the information mapping platform 103 may also apply external filters or criteria applied by information providers 115, the service platform 111, network operator, etc. For example, one external criteria may form a two-way link (essentially a tunnel through the Earth) between all or selected users and/or locations. This tunnel, for instance, restricts or filters location information so that only a specific set of users (e.g., users located in a first location) can view location information originating at a second location. For example, information originating in New York may be restricted to viewing by only those users located in Tokyo. As described, this restriction, in essence, creates a “tunnel” from Tokyo to New York so that users in other locations will not have access to the restricted location information. Accordingly, the UE 101a renders a user interface presenting the desired information items and location information specified in the received information list (at 1115).

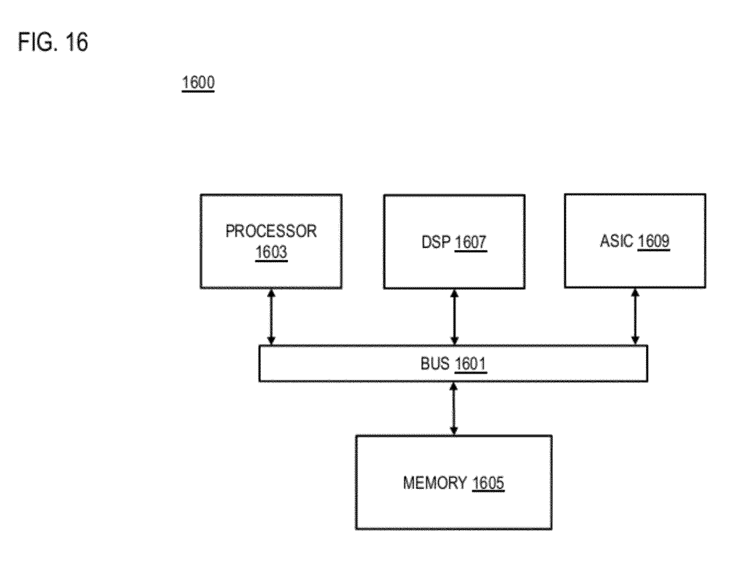

FIG. 12 is a flowchart of a process for presenting a user interface depicting a first person world view of desired information, according to one embodiment. In one embodiment, the runtime module 905 performs the process 1200 and is implemented in, for instance, a chip set including a processor and a memory as shown FIG. 16. The process 1200 assumes that the runtime module 905 has already completed the process 900 for verifying location information items and is now determining the type of user interface for rendering the verified location information.

In step 1201, the runtime module determines whether to render the user interface as an augmented reality view incorporating the transparency effect or as a map highlighting and aggregating location information. The determination is based, for instance, on user preference that may be requested at the time of rendering or may be preconfigured in a user profile or a default setting. If the choice is to present an augmented reality view (e.g., a globe view), the runtime module 905 initiates determination of a location, directional heading, and angle of elevation of the UE 101 to determine a viewpoint from which to render the view (step 1203). In one embodiment, the viewpoint parameters (e.g., location, direction heading, and angle of elevation of the UE 101) are determined by pointing the user UE 101 at a specific place in the physical world. More specifically, to determine where the UE 101 is pointed, the runtime module 905 may utilize the location module 909, magnetometer module 911, accelerometer module 913, or a combination thereof. In other embodiments, the user may select the viewpoint based on a 3D environment. The user may select the viewpoint based on conventional means of searching a map or 3D map (e.g., by selecting a starting point and traversing the map or entering location coordinates, such as GPS coordinates or an address, of the viewpoint).

From the selected viewpoint, an image representing an augmented reality view or a 3D model of the location corresponding to the viewpoint can be generated or retrieved from the cache 907 or the information mapping platform 103 (step 1205). As previously noted, the image may represent a physical environment, which may be captured using an image capture module 117 of the UE 101. In another embodiment, the image may represent a virtual 3D environment, where the user's location in the real world physical environment is represented in the virtual 3D environment. In the representation, the viewpoint of the user is mapped onto the virtual 3D environment. Moreover, a hybrid physical and virtual 3D environment may additionally be utilized to present navigational information to the user.

The runtime module 905 can then further render or indicate the location information of one or more information items in the augmented reality user interface (step 1207). It is noted that to enable seeing the globe effect and the information simultaneously, the amount of information shown can be restricted or reduced (e.g., using adjustable zoom or detail levels) so that information labels do not obscure the globe. In certain embodiments, when there is much more information available than can be displayed in the existing globe view use interface, the runtime module 905 can be constantly animating the display of the information items so that new information keeps appearing while older information disappears. This animation process also makes the user interface more entertaining to users and gives a feeling of the world being “alive” with activity.

Additionally, because of the large scale of the world, fine granularities of distances are not readily displayed or visible in the rendered user interface. Accordingly, the exact locations of people and information are less important which can guard against some privacy concerns when sharing people tracking data. For example, when rendering the augmented reality view from across the globe, the scale of the display enables the runtime module 905 to indicate a specific location with accuracy to generally the city or regional level. As a result, the large scale of the view limits how accurately the location tracking data can be displayed, thereby protecting the privacy of those participating in the people tracking service.

In certain embodiment, the user may specify a zooming range or granularity for rendering the user interface. For example, the user may have the option to select a range for distance (e.g., a display scale) or a level of accuracy or sensitivity for determining the viewpoint (e.g., the location, directional heading, and tilt angle) of the UE 101. The range selection can use traditional numerical input or natural language input (e.g., outer space, the sky above the buildings, above ground on the other side of the Earth, etc.). The range may also be specified by zooming controls in a touch-based user interface, or a slider, actuator, knob, or other similar user interface element. Moreover, it is contemplated that the sensitivity for determining the viewpoint can be automatically adjusted based on the zoom, thereby advantageously reducing the effects of the natural unsteadiness of the user's pointing of the UE 101 that is exacerbated at higher levels of zoom. As zoom increases, the exact locations of the location tracking subjects may be automatically obscured to protect the privacy of the location tracking subjects or other location information displayed in the user interface.

The zoom level also affects the amount of information or other data that can be displayed in the user interface. In addition, the user can add filters (e.g., based on information subject, type, etc.) to select the types of information to display in the user interface. In one embodiment, the user can also define the range where information is visible in the user interface, so that the user can, for instance, see only the desired information items around a particular city that is near the horizon. Another example would be to define a very short range for viewing subway lines under a city. In yet another embodiment, the user interface may employ a visualization method similar to a camera auto-focus, so that the information that is under the “point of focus” is rendered normally, while the rest of the view user interface is blurred as if it was out of focus. In this way, the user interface more clearly presents the information at which the viewpoint is directed. As the viewpoint changes from one information item to the next, the focus can shift accordingly.

An inherent property of an augmented reality user interface is that the displayed information is dependent on the viewpoint and that to view a specific point or information located on the Earth, the user has to point the UE 101 in the correct direction. In addition or alternatively, the user may specify a particular viewpoint by entering at least one of a location, directional heading, and tilt angle rather than point the UE 101 manually. In this way, the user can virtually aim the UE 101 instead of manually pointing. Based on the manually specified viewpoint, the user interface may be rendered to depict the scene virtually using, for instance, such as a wireframe rendering, a tunnel or pipe graphical element, or other indication to signify that the presentation is based on a virtual viewpoint. To facilitate finding specific information or features, the runtime module 905 enables the user to input search criteria (e.g., an information item, person, city, weather, etc.) and get guidance for finding the direction where the searched information item is located in the real physical world. By way of example, the guidance may, as discussed above, be indicated as a directional arrow or other similar indicator in the augmented reality display to indicate the direction the user should adjust the user interface or point the UE 101 in order to find the searched information item. Therefore, as the user adjusts the user interface or moves the UE 101a, the runtime module 905 updates the rendering of the user interface to reflect the new viewpoint (step 1209).

As an alternative to the augmented reality or globe view user interface, the runtime module 905 can provide a simple and intuitive map view of the information items and their corresponding location (step 1211). In this view, the runtime module 905 renders graphical representations of the information items and places them on the map according to the location information corresponding to each information item. As with the augmented reality view point, the zoom and detail levels of the display can be varied to ensure that the map is not completely obscured. Additionally, information items can be animated to appear and disappear from the view based on date, user preferences, or other criteria to further reduce number of information items to display.

FIG. 13 is a flowchart of a process for locking an augmented reality user interface at a fixed position, according to one embodiment. As noted previously, an inherent property of an augmented reality user interface is that the display follows the movement and pointing of the UE 101. However, in some cases (e.g., when the user has found and is displaying a favorite location), the user may wish to “lock” or fix the display at a particular viewpoint without having to maintain the UE 101 in the same position. Accordingly, at step 1301, the runtime module receives input from the UE 101 for locking the viewpoint parameters (e.g., location, directional heading, and angle of elevation) of the UE 101 at a fixed viewpoint. This input may be initiated, for instance, selecting a menu option or actuating a physical button (e.g., a shutter release of the image capture module 117). In one embodiment, the image capture module 117 may also be used to “lock” the viewpoint of the UE 101, so that even if the UE 101 is moved or turned away, the runtime module 905 renders the desired information from the locked viewpoint (step 1303). Using a camera metaphor, this would mean taking a “living photograph” of the shown view, whereby the information depicted in the locked viewpoint keeps updating even though the direction does not (step 1305). In this way, the user can select a favorite viewpoint (e.g., a view of New York City through the transparent Earth) and monitor the development of evolution of available information originating from the location in the locked viewpoint. It is further contemplated that the user may store one or more of the locked viewpoints for later reference or recall.

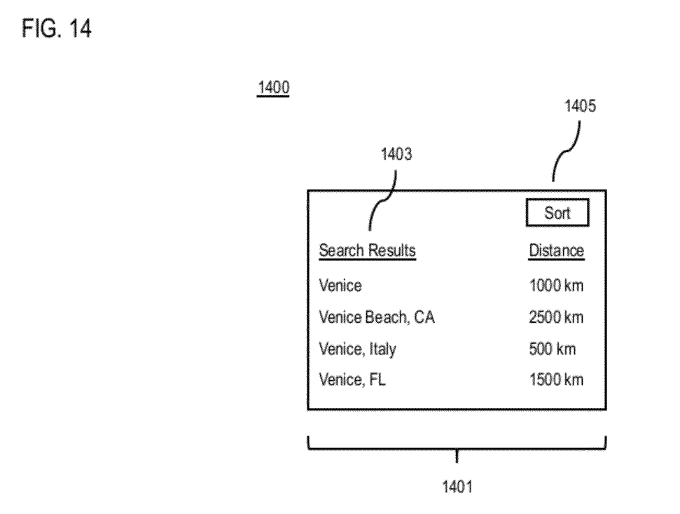

FIG. 14 is diagram of a user interface utilized to update available relevant information, according to one embodiment. As an alternate to the graphical map interface of FIG. 11, the user interface 1400 depicts a list view of global information wherein the search results of all available or potential information items 1403 are displayed in a table 1401. In this example, the information items have been filtered to show only top ten most relevant information items based on proximity to the UE 101's location. The user interface 1400 enables sorting and display by any available descriptive column or field by way of a sort element 1405.

The processes described herein for presenting a global view of desired information may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

The information list view enables the user to quickly view information items, for instance, when a user wants to add, delete, or modify one or more information items in the list by way of a command button 1310.

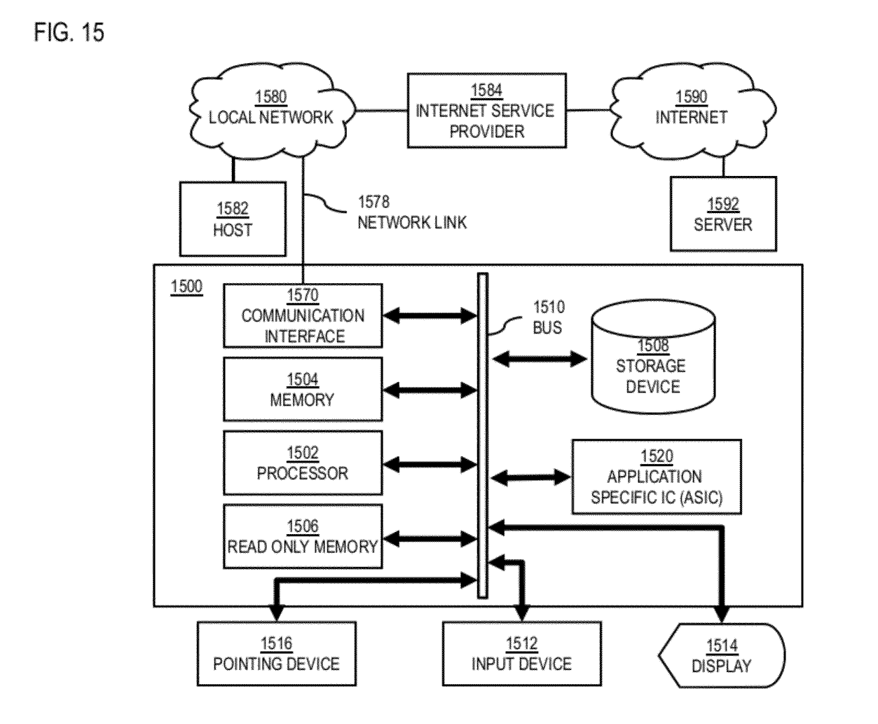

FIG. 15 illustrates a computer system 1500 upon which an embodiment of the invention may be implemented. Although computer system 1500 is depicted with respect to a particular device or equipment, it is contemplated that other devices or equipment (e.g., network elements, servers, etc.) within FIG. 15 can deploy the illustrated hardware and components of system 1500. Computer system 1500 is programmed (e.g., via computer program code or instructions) to present a global view of information as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of presenting a global view of information.

A bus 1510 includes one or more parallel conductors of information so that information is transferred quickly among devices coupled to the bus 1510. One or more processors 1502 for processing information are coupled with the bus 1510.

A processor 1502 performs a set of operations on information as specified by computer program code related to present a global view of information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1500 also includes a memory 1504 coupled to bus 1510. The memory 1504, such as a random access memory (RAM) or other dynamic storage device, stores information including processor instructions for presenting a global view of information. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions for presenting a global view of information, is provided to the bus 1510 for use by the processor from an external input device 1512, such as a keyboard containing alphanumeric keys operated by a human user, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT) or a liquid crystal display (LCD), or plasma screen or printer for presenting text or images, and a pointing device 1516, such as a mouse or a trackball or cursor direction keys, or motion sensor, for controlling a position of a small cursor image presented on the display 1514 and issuing commands associated with graphical elements presented on the display 1514. In some embodiments, for example, in embodiments in which the computer system 1500 performs all functions automatically without human input, one or more of external input device 1512, display device 1514 and pointing device 1516 is omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 105 for presenting a global view of information.

The term “computer-readable medium” as used herein to refers to any medium that participates in providing information to processor 1502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1508. Volatile media include, for example, dynamic memory 1504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1520.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system 1500 can be deployed in various configurations within other computer systems, e.g., host 1582 and server 1592.

At least some embodiments of the invention are related to the use of computer system 1500 for implementing some or all of the techniques described herein. According to one embodiment of the invention, those techniques are performed by computer system 1500 in response to processor 1502 executing one or more sequences of one or more processor instructions contained in memory 1504. Such instructions, also called computer instructions, software and program code, may be read into memory 1504 from another computer-readable medium such as storage device 1508 or network link 1578. Execution of the sequences of instructions contained in memory 1504 causes processor 1502 to perform one or more of the method steps described herein. In alternative embodiments, hardware, such as ASIC 1520, may be used in place of or in combination with software to implement the invention. Thus, embodiments of the invention are not limited to any specific combination of hardware and software, unless otherwise explicitly stated herein.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server host 1592 transmits program code for a particular application, requested by a message sent from computer 1500, through Internet 1590, ISP equipment 1584, local network 1580 and communications interface 1570. The received code may be executed by processor 1502 as it is received, or may be stored in memory 1504 or in storage device 1508 or other non-volatile storage for later execution, or both. In this manner, computer system 1500 may obtain application program code in the form of signals on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

FIG. 16 illustrates a chip set 1600 upon which an embodiment of the invention may be implemented. Chip set 1600 is programmed to present a global view of information as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1600, or a portion thereof, constitutes a means for performing one or more steps of presenting a global view of information.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to present a global view of information. The memory 1605 also stores the data associated with or generated by the execution of the inventive steps.

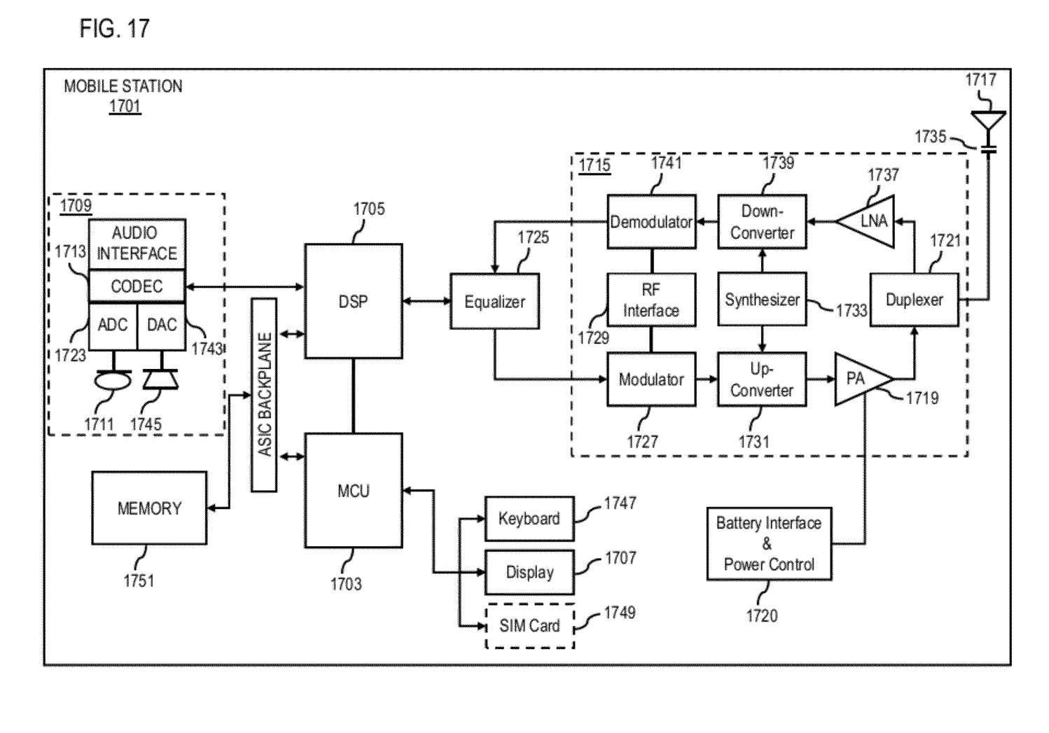

FIG. 17 is a diagram of exemplary components of a mobile terminal (e.g., handset) for communications, which is capable of operating in the system of FIG. 1, according to one embodiment. In some embodiments, mobile terminal 1700, or a portion thereof, constitutes a means for performing one or more steps of presenting a global view of information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile device or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile device or a similar integrated circuit in a cellular network device or other network devices.

Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile terminal functions that perform or support the steps of presenting a global view of information. The display 1707 includes display circuitry configured to display at least a portion of a user interface of the mobile terminal (e.g., mobile telephone). Additionally, the display 1707 and display circuitry are configured to facilitate user control of at least some functions of the mobile terminal. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile terminal 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, other mobile device or a land-line connected to a Public Switched Telephone Network (PSTN), or other telephony networks.

Voice signals transmitted to the mobile terminal 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703—which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile terminal 1701 to present a global view of information. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the terminal. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile terminal 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile terminal 1701 on a radio network. The card 1749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
one or more search parameters at an element of a user interface, the element presented at a position within the user interface;
a processing of the one or more search parameters to determine one or more search results;
at least one determination of one or more other positions within the user interface based, at least in part, on the one or more search results; and
a presentation of the element at at least one of the one or more other positions.

2. A method of claim 1, wherein the (1) data and/or (2) information and/or (3) at least one signal are further based, at least in part, on at least one determination to generate an animation depicting, at least in part, a movement of the element from the position to the at least one of the one or more other positions.

3. A method of claim 2, wherein the (1) data and/or (2) information and/or (3) at least one signal are further based, at least in part, on at least one determination to generate another animation depicting, at least in part, a movement of the element from at least one of the one or more other positions to any other position branching from any of the one or more other positions.

4. A method of claim 1, wherein the (1) data and/or (2) information and/or (3) at least one signal are further based, at least in part, on the following:
at least one determination to generate an indicator based, at least in part, on (a) the position of the at least one element with respect to the one or more other positions, (b) a function of the at least one element, (c) a status of the function, or (d) a combination thereof; and
a presentation of the indicator in the least one element.

5. A method of claim 1, wherein the (1) data and/or (2) information and/or (3) at least one signal are further based, at least in part, on the following:
a range of the one or more search parameters determined based on receiving a direction from the element,
wherein the one or more search results are further based, at least in part, on the range.

6. A method of claim 5, wherein the element further comprises a switch to change the range between at least two default values.

7. A method of claim 6, wherein the element further comprises another switch to change a transparency amount of a view within the user interface.

8. A method of claim 1, wherein the (1) data and/or (2) information and/or (3) at least one signal are further based, at least in part, on the following:
at least one determination of whether the element is to be presented on the user interface at the one or more other positions based on a constraint; and
a presentation of at least one direction indicator to illustrate a direction of at least one of the one or more positions that is determined to not be presented on the user interface.

9. A method of claim 8, wherein the (1) data and/or (2) information and/or (3) at least one signal are further based, at least in part, on an adjustment of the user interface so that the element presented at the one or more other positions that are in the direction indicated by the direction indicator are presented on the user interface.

10. A method of claim 1, wherein the user interface is at least one of a map, a document, an image, a game, an augmented reality application, and a virtual reality application that includes the element.

11. An apparatus comprising:
at least one processor; and
at least one memory including computer program code for one or more programs,
the at least one memory and the computer program code configured to, with the at least one processor, cause the apparatus to perform at least the following,
receive of one or more search parameters at an element of a user interface, the element presented at a position within the user interface;
process and/or facilitate a processing of the one or more search parameters to determine one or more search results;
determine one or more other positions within the user interface based, at least in part, on the one or more search results; and
cause, at least in part, a presentation of the element at at least one of the one or more other positions.

12. An apparatus of claim 11, wherein the apparatus is further caused to:
determine to generate an animation depicting, at least in part, a movement of the element from the position to the at least one of the one or more other positions.

13. An apparatus of claim 12, wherein the apparatus is further caused to:
determine to generate another animation depicting, at least in part, a movement of the element from at least one of the one or more other positions to any other position branching from any of the one or more other positions.

14. An apparatus of claim 11, wherein the apparatus is further caused to:
determine to generate an indicator based, at least in part, on (a) the position of the at least one element with respect to the one or more other positions, (b) a function of the at least one element, (c) a status of the function, or (d) a combination thereof; and
determine to cause, at least in part, a presentation of the indicator in the least one element.

15. An apparatus of claim 11, wherein the apparatus is further caused to:
determine a range of the one or more search parameters based on receiving a direction from the element,
wherein the one or more search results are further based, at least in part, on the range.

16. An apparatus of claim 15, wherein the element further comprises a switch to change the range between at least two default values.

17. An apparatus of claim 16, wherein the element further comprises another switch to change a transparency amount of a view within the user interface.

18. An apparatus of claim 11, wherein the apparatus is further caused to:
determine whether the element is to be presented on the user interface at the one or more other positions based on a constraint; and
determine to cause, at least in part, a presentation of at least one direction indicator to illustrate a direction of at least one of the one or more positions that is determined to not be presented on the user interface.

19. An apparatus of claim 18, wherein the apparatus is further caused to:
determine to cause, at least in part, an adjustment of the user interface so that the element presented at the one or more other positions that are in the direction indicated by the direction indicator are presented on the user interface.

20. An apparatus of claim 11, wherein the user interface is at least one of a map, a document, an image, a game, an augmented reality application, and a virtual reality application that includes the element.
